(19) United States
(12) Patent Application Publication
(10) Pub. No.: US 2021/0046563 A1
(43) Pub. Date: Feb. 18, 2021

(54) Saw Blade

(71) Applicant: Karl Jacob PETERSON, Tauranga (NZ)

(72) Inventor: Karl Jacob PETERSON, Tauranga (NZ)

(21) Appl. No.: 16/993,817

(22) Filed: Aug. 14, 2020

(30) Foreign Application Priority Data
Aug. 16, 2019 (NZ) 756 450

(51) Int. Cl. B23D 61/02

(52) U.S. Cl. CPC B23D 61/021; B23D 61/025

(57) ABSTRACT

The invention relates to a saw blade 1 comprising a circular disc 2 having curved recesses 3 around its circumference. Each recess has a notch 5; a series of teeth 4 fitted within the recesses. Each tooth has a cutting bit 7 and a shank 6 separate from one another until installed. Each cutting bit 7 has a base with an aperture 14 therein; and a plurality of fixing members 13, The arrangement is characterised in that for each tooth 4, one of the fixing members 13 is engaged with the aperture 14 and extends from the cutting bit 7 to also engage a corresponding one of the notches 5 to restrain the tooth 4 from becoming dislodged from the recess 3 it is in.

### FIELD OF INVENTION

This invention relates to a circular saw blade.

### BACKGROUND

It is known for a circular saw blade to incorporate a disc, and to have its teeth separately fixed in the disc. Each tooth may comprise a shank and a sharp cutting bit. The shank engages the disc, and the bit extends outwardly for cutting timber or some other material.

Having the teeth separate means they can be replaced individually when worn or damaged without having to discard the rest of the blade. A problem with such blades is that the teeth may become dislodged from the disc due to the normal centrifugal forces incurred during cutting, or if for example they unexpectedly contact a hard object in the timber being worked on, e.g. a nail. This presents a danger to people working near the blade.

### OBJECT

It is an object of preferred embodiments of the invention to at least go some way towards addressing this problem. While this applies to preferred embodiments it should be understood that the object of the invention per se is simply to provide the public with a useful choice. Therefore, any objects, advantages or benefits applicable to preferred embodiments should not be taken as a limitation on any claim expressed more broadly.

### SUMMARY OF THE INVENTION

According to one aspect of the invention there is provided a saw blade comprising:
a circular disc having curved recesses around its circumference, each recess having a notch;
a series of teeth fitted within the recesses, each tooth comprising a cutting bit and a shank separate from one another until installed, each cutting bit having a base with an aperture therein; and
a plurality of fixing members;
characterised in that for each tooth, one of the fixing members is engaged with the aperture and extends from the cutting bit to also engage a corresponding one of the notches to restrain the tooth from becoming dislodged from the recess it is in.

Optionally each shank has a node that locates in a bay of the cutting bit.

Optionally for each bit the base locates in a shoulder of the corresponding recess.

Optionally each tooth has a V shaped edge that engages a complimentary shaped edge of its corresponding recess, in a male-female fit.

Optionally the fixing members comprise screws or rolled pins.

Optionally the screws comprise grub screws.

Optionally the screws are tapered.

Optionally each recess and each tooth are generally crescent shaped.

Optionally each tooth has a shank and a cutting bit that are integral.

Optionally each blade has a kerf that is no more than 10 mm thick.

Optionally each blade has a kerf that is no more than 9 mm thick.

Optionally each blade has a kerf that is no more that 8 mm thick Optionally each blade has a kerf that is no more than 7 mm thick Optionally each blade has a kerf that is no more than 6 mm thick.

Optionally each recess comprises an arcuate major edge and an arcuate minor edge with a step between such that one edge is offset from the other, and for each recess the bit is located against the shoulder and the shank extends across the shoulder and engages with the bit such that the tooth is prevented from sliding out of the recess by way of a tight ‘concentric cam-fit’ engagement between the shank and the bit.

### DRAWINGS

Some preferred embodiments of the invention will now be described by way of example and with reference to the accompanying drawings, of which:

FIG. 1 is a side view of a circular saw blade;

FIG. 2 is a side view illustrating detail of a recess forming part of the blade;

FIG. 3 is an isometric view illustrating how the teeth are fitted to the recesses;

FIG. 4 is a side view also illustrating how the teeth are fitted to the recesses; and

FIG. 5 is a close-up view of part of one of the teeth

### DETAILED DESCRIPTION

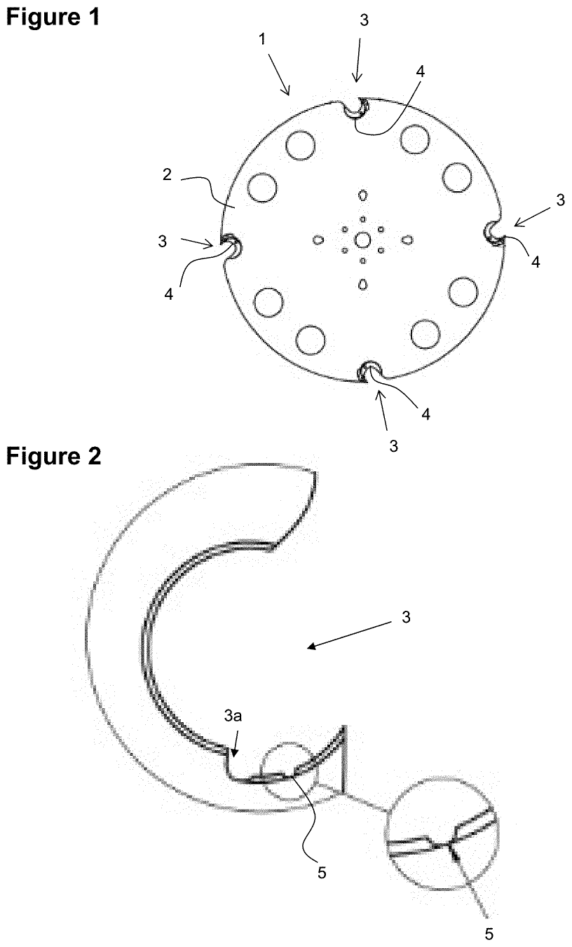

Referring to FIG. 1, the saw blade 1 comprises a metallic disc 2 having a series of generally crescent shaped recesses 3. Each recess is fitted with a complimentary crescent shaped replaceable tooth 4.

FIG. 2 provides detail of one of the recesses 3, but without its tooth. As indicated, each recess has a notch 5. In this example the notch is generally semi-circular, but alternative shapes may be used if desired. As can be seen, the recess 3 has a step or shoulder 3a at one end.

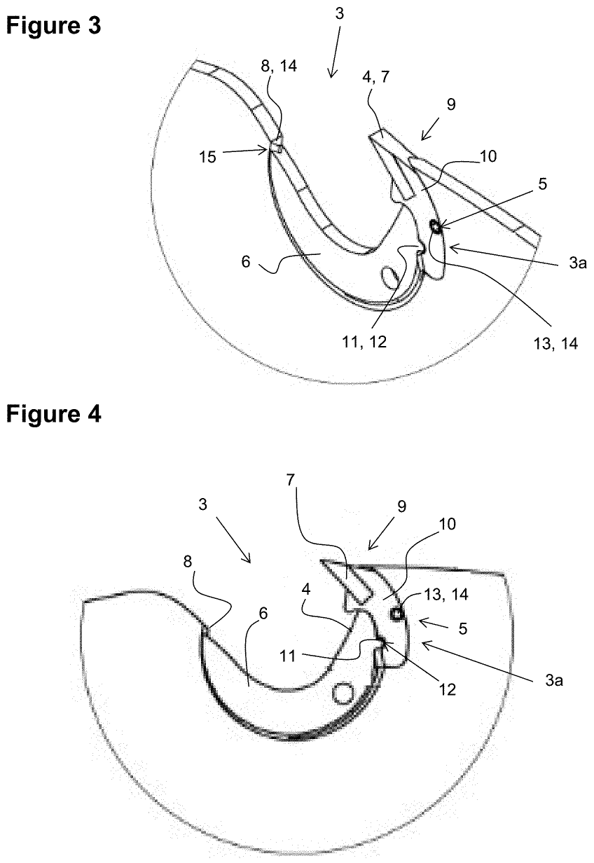

FIGS. 3 & 4 provide detail of the recess 3 when fitted with one of the teeth 4. Each tooth comprises a metallic shank 6 and a cutting bit 7. Preferably the bit 7 is at least in part formed from carbide. The end of the shank 6 that is furthest from the bit 7 lodges against a ledge 8 of the recess. The ledge 8 prevents the shank from sliding out of the recess at that end. The tooth's other end 9 is prevented from sliding out of the recess by way of a tight ‘concentric cam-fit’ engagement between the shank 6 and the base 10 of the cutting bit. This is facilitated by the curvature of the recess 3, and by a node 11 of the shank that locates in a bay 12 of the bit 7. As shown, the bit 7 is located in the shoulder 3a to assist with the cam engagement.

A fixing member, for example a tapered grub screw 13, is screw fitted into a correspondingly tapered aperture 14 of the base 10, so that the screw 13 sits in the notch 5. In other embodiments, a roll pin may be used instead of a grub screw.

Preferably the screw 13 passes completely through the notch 5, although in other embodiments it may only locate in part of the notch. In either case the screw 13 lodges in the notch 5, and thereby prevents the tooth 4 from sliding forward out of the recess 3. This serves to more securely fix the tooth to the rest of the blade. The saw's other teeth are arranged the same way.

As indicated in FIG. 3, an inverted ‘V’ shaped (e.g. A) male edge or raceway 14 runs along the periphery of the recess 3. This provides a type of track for receiving a complimentary (e.g. ‘V’) shaped female inner edge 15 of the tooth. This ‘V on V’ engagement prevents each tooth from moving sideways out of the recess.

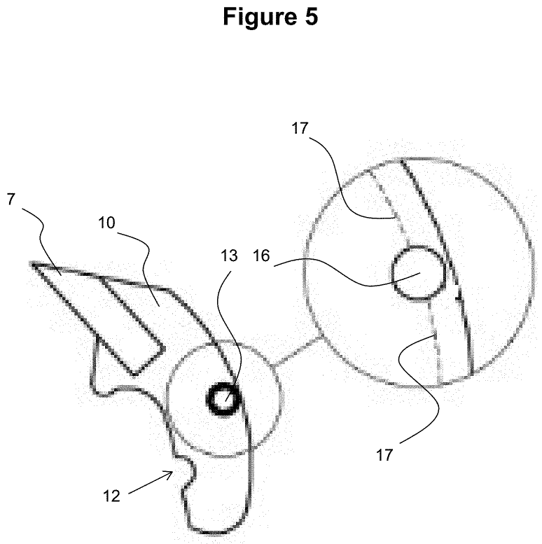

FIG. 5 provides more detail of the location of the tooth's aperture 16 that receives the grub screw 13. In this example the aperture is a regular hole, but in other embodiments it may be open at one side like a notch, etc. The outer edge of the disc's recess 3 is indicated by the broken lines at 17.

To assemble the saw blade the crescent shaped edge of the shank 6, and the crescent shaped edge of the bit's base 10, are rolled into place using a lever. The grub screw 13 is then inserted into the aperture 16 so that the screw extends into the recess' notch 5. In some embodiments of the invention the notch 5 can be created by way of a hand-file, i.e. to cut into the recess 3 prior to installation of the tooth 4. This is repeated for each recess and tooth. To remove each tooth the grub screw can be unscrewed, or punched free, and the tooth levered out.

While the above teeth 4 are made up of separate parts, i.e. from the shank 6 and cutting bit 7, in alternative embodiments these may be in one piece. However having the shank separate from the bit means that if the bit is worn or damaged it can be replaced, without having to replace the shank. In still further embodiments the blade may be as above, but with two or more notches and two grub screws per tooth. A grub screw-notch engagement as above may be used between the shank and the recess if desired.

Preferably the kerf or thickness of the blade is no more than 10 mm, preferably no more than 8 mm, 7 mm or 6 mm.

While some preferred embodiments of the invention have been described by way of example it should be appreciated that modifications and improvements can occur without departing from the scope of the following claims.

In terms of disclosure, this document hereby discloses each item, feature or step mentioned herein in combination with one or more of any of the other item, feature or step disclosed herein, in each case regardless of whether such combination is claimed.

1. A saw blade comprising:
a circular disc having curved recesses around its circumference, each recess having a notch;
a series of teeth fitted within the recesses, each tooth comprising a cutting bit and a shank separate from one another until installed, each cutting bit having a base with an aperture therein; and
a plurality of fixing members;
characterised in that for each tooth, one of the fixing members is engaged with the aperture and extends from the cutting bit to also engage a corresponding one of the notches to restrain the tooth from becoming dislodged from the recess it is in.

2. A circular saw blade according to claim 1, wherein each shank has a node that locates in a bay of the cutting bit.

3. A circular saw blade according to claim 2, wherein for each bit the base locates in a shoulder of the corresponding recess.

4. A circular saw blade according to claim 3, wherein each tooth has a V shaped edge that engages a complimentary shaped edge of its corresponding recess, in a male-female fit.

5. A circular saw blade according to claim 4, wherein the fixing members comprise screws or rolled pins.

6. A circular saw blade according to claim 5, wherein the screws comprise grub screws.

7. A circular saw blade according to claim 6, wherein the screws are tapered.

8. A circular saw blade according to claim 7, wherein each recess and each tooth are generally crescent shaped.

9. A circular saw blade according to claim 1, wherein each tooth has a shank and a cutting bit that are integral.

10. A circular saw blade according to claim 8, where in the blade has a kerf of no more than 10 mm thick.

11. A circular saw blade according to claim 8, wherein the blade has a kerf of no more than 9 mm thick.

12. A circular saw blade according to claim 8, wherein the blade has a kerf of no more than 8 mm thick.

13. A circular saw blade according to claim 8, wherein the blade has a kerf of no more than 7 mm thick.

14. A circular saw blade according to claim 8, wherein the blade has a kerf of no more than 6 mm thick.

15. A circular saw blade according to claim 1, wherein:
each shank has a node that locates in a bay of the cutting bit;
each bit has a base that locates in a shoulder of the corresponding recess;
each tooth has a V shaped edge that engages a complimentary shaped edge of its corresponding recess, in a male-female fit;
each fixing member comprises a grub screw; and
each recess and each tooth are generally crescent shaped.

16. A circular saw blade according to claim 1, wherein each recess comprises an arcuate major edge and an arcuate minor edge with a step between such that one edge is offset from the other, and for each recess the bit is located against the shoulder and the shank extends across the shoulder and engages with the bit such that the tooth is prevented from sliding out of the recess by way of a tight ‘concentric cam-fit’ engagement between the shank and the bit.
